(19) United States
(12) Patent Application Publication
(10) Pub. No.: US 2003/0105633 A1
(43) Pub. Date: Jun. 5, 2003

(54) Speech recognition with a complementary language model for typical mistakes in spoken dialogue

(76) Inventors: Christophe Delaunay, Rennes (FR); Frederic Soufflet, Chateaugiron (FR); Nour-Eddine Tazine, Noyal sur Vilaine (FR)

Correspondence Address: Joseph S Tripoli, Thomson Multimedia Licensing Inc, CN 5312, Princeton, NJ, 08543-0028, US

(21) Appl. No.: 10/148,297

(22) PCT Filed: Nov. 29, 2000
(86) PCT No.: PCT/FR00/03329

(30) Foreign Application Priority Data
Dec. 2, 1999 (FR) 99/15190

(51) Int. Cl. G10L 15/28

(52) U.S. Cl. 704/255

(57) ABSTRACT

The invention relates to a voice recognition device (1) comprising an audio processor (2) for the acquisition of an audio signal and a linguistic decoder (6) for determining a sequence of words corresponding to the audio signal.

The linguistic decoder of the device of the invention comprises a language model (8) determined on the basis of a first set of at least one syntactic block defined solely by a grammar and of a second set of at least one second syntactic block defined by one of the following elements, or a combination of these elements: a grammar, a list of phrases, an n-gram network.

The invention relates to a voice recognition device comprising a language model defined with the aid of syntactic blocks of different kinds, referred to as rigid blocks and flexible blocks.

Information systems or control systems are making ever increasing use of a voice interface to make interaction with the user fast and intuitive. Since these systems are becoming more complex, the dialogue styles supported are becoming ever more rich, and one is entering the field of very large vocabulary continuous voice recognition.

It is known that the design of a large vocabulary continuous voice recognition system requires the production of a Language Model which defines the probability that a given word from the vocabulary of the application follows another word or group of words, in the chronological order of the sentence.

This language model must reproduce the speaking style ordinarily employed by a user of the system: hesitations, false starts, changes of mind, etc.

The quality of the language model used greatly influences the reliability of the voice recognition. This quality is most often measured by an index referred to as the perplexity of the language model, and which schematically represents the number of choices which the system must make for each decoded word. The lower this perplexity, the better the quality.

The language model is necessary to translate the voice signal into a textual string of words, a step often used by dialogue systems. It is then necessary to construct a comprehension logic which makes it possible to comprehend the vocally formulated query so as to reply to it.

There are two standard methods for producing large vocabulary language models:

(1) the so-called N-gram statistical method, most often employing a bigram or trigram, consists in assuming that the probability of occurrence of a word in the sentence depends solely on the N words which precede it, independently of its context in the sentence.

If one takes the example of the trigram for a vocabulary of 1000 words, as there are 1000³ possible groups of three elements, it would be necessary to define 1000³ probabilities to define the language model, thereby tying up a considerable memory size and very great computational power. To solve this problem, the words are grouped into sets which are either defined explicitly by the model designer, or deduced by self-organizing methods.

This language model is constructed from a text corpus automatically.

(2) The second method consists in describing the syntax by means of a probabilistic grammar, typically a context-free grammar defined by virtue of a set of rules described in the so-called Backus Naur Form or BNF form.

The rules describing grammars are most often handwritten, but may also be deduced automatically. In this regard, reference may be made to the following document:

“Basic methods of probabilistic context-free grammars” by F. Jelinek, J. D. Lafferty and R. L. Mercer, NATO ASI Series Vol. 75 pp. 345-359, 1992.

The models described above raise specific problems when they are applied to interfaces of natural language systems:

The N-gram type language models (1) do not correctly model the dependencies between several distant grammatical substructures in the sentence. For a syntactically correct uttered sentence, there is nothing to guarantee that these substructures will be complied with in the course of recognition, and therefore it is difficult to determine whether such and such a sense, customarily borne by one or more specific syntactic structures, is conveyed by the sentence.

These models are suitable for continuous dictation, but their application in dialogue systems suffers from the defects mentioned.

On the other hand, it is possible, in an N-gram type model, to take account of hesitations and repetitions, by defining sets of words grouping together the words which have actually been recently uttered.

The models based on grammars (2) make it possible to correctly model the remote dependencies in a sentence, and also to comply with specific syntactic substructures. The perplexity of the language obtained is often lower, for a given application, than for the N-gram type models.

On the other hand, they are poorly suited to the description of a spoken language style, with incorporation of hesitations, false starts, etc. Specifically, these phenomena related to the spoken language cannot be predicted and it would therefore seem to be difficult to design grammars which, by dint of their nature, are based on language rules.

Moreover, the number of rules required to cover an application is very large, thereby making it difficult to take into account new sentences to be added to the dialogue envisaged without modifying the existing rules.

The subject of the invention is a voice recognition device comprising an audio processor for the acquisition of an audio signal and a linguistic decoder for determining a sequence of words corresponding to the audio signal, the decoder comprising a language model (8), characterized in that the language model (8) is determined by two sets of blocks. The first set comprises at least one rigid syntactic block and the second set comprises at least one flexible syntactic block.

The association of the two types of syntactic blocks enables the problems related to the spoken language to be easily solved while benefiting from the modelling of the dependencies between the elements of a sentence, modelling which can easily be processed with the aid of a rigid syntactic block.

According to one feature, the first set of rigid syntactic blocks is defined by a BNF type grammar.

According to another feature, the second set of flexible syntactic blocks is defined by one or more n-gram networks, the data of the n-gram networks being produced with the aid of a grammar or of a list of phrases.

According to another feature, the n-gram networks contained in the second flexible blocks contain data allowing recognition of the following phenomena of spoken language: simple hesitation, simple repetition, simple exchange, change of mind, mumbling.

The language model according to the invention permits the combination of the advantages of the two systems, by defining two types of entities which combine to form the final language model.

A rigid syntax is retained in respect of certain entities and a parser is associated with them, while others are described by an n-gram type network.

Moreover, according to a variant embodiment, free blocks “triggered” by blocks of one of the previous types are defined.

Other characteristics and advantages of the invention will become apparent through the description of a particular non-limiting embodiment, explained with the aid of the appended drawings in which:

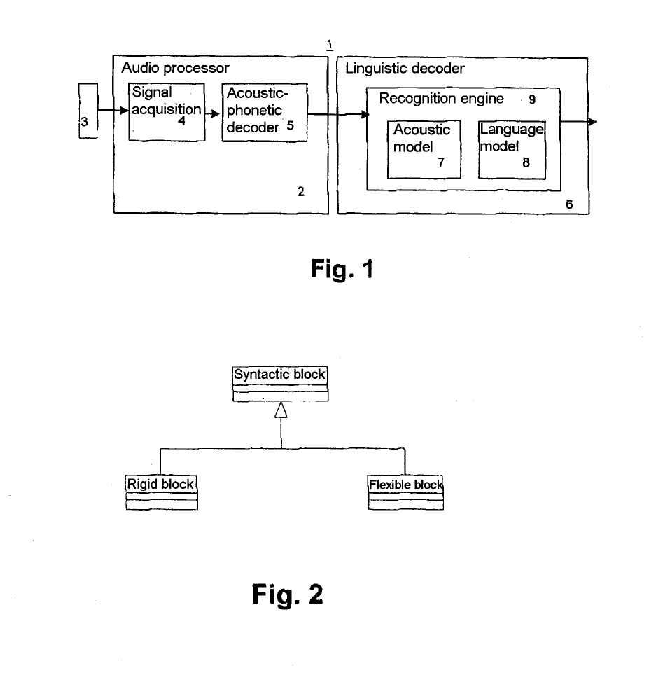

FIG. 1 is a diagram of a voice recognition system,

FIG. 2 is an OMT diagram defining a syntactic block according to the invention.

FIG. 1 is a block diagram of an exemplary device 1 for speech recognition. This device includes a processor 2 of the audio signal carrying out the digitization of an audio signal originating from a microphone 3 by way of a signal acquisition circuit 4. The processor also translates the digital samples into acoustic symbols chosen from a predetermined alphabet. For this purpose, it includes an acoustic-phonetic decoder 5. A linguistic decoder 6 processes these symbols so as to determine, for a sequence A of symbols, the most probable sequence W of words, given the sequence A.

The linguistic decoder uses an acoustic model 7 and a language model 8 implemented by a hypothesis-based search algorithm 9. The acoustic model is for example a so-called “hidden Markov” model (or HMM) . The language model implemented in the present exemplary embodiment is based on a grammar described with the aid of syntax rules of the Backus Naur form. The language model is used to submit hypotheses to the search algorithm. The latter, which is the recognition engine proper, is, as regards the present example, a search algorithm based on a Viterbi type algorithm and referred to as “n-best”. The n-best type algorithm determines at each step of the analysis of a sentence the n most probable sequences of words. At the end of the sentence, the most probable solution is chosen from among the n candidates.

The concepts in the above paragraph are in themselves well known to the person skilled in the art, but information relating in particular to the n-best algorithm is given in the work:

“Statistical methods for speech recognition” by F. Jelinek, MIT Press 1999 ISBN 0-262-10066-5 pp. 79-84. Other algorithms may also be implemented. In particular, other algorithms of the “Beam Search” type, of which the “n-best” algorithm is one example.

The language model of the invention uses syntactic blocks which may be of one of the two types illustrated by FIG. 2: block of rigid type, block of flexible type.

The rigid syntactic blocks are defined by virtue of a BNF type syntax, with five rules of writing:

(a) <symbol A>=<symbol B>|<symbol C> (or symbol)

(b) <symbol A>=<symbol B><symbol C> (and symbol)

(c) <symbol A>=<symbol B> ? (optional symbol)

(d) <symbol A>=“lexical word” (lexical assignment)

(e) <symbol A>=P{<symbol B>, <symbol C>, . . . <symbol X>} (symbol B> <symbol C>)

( . . . )

(symbol I> <symbol J>)

(all the repetitionless permutations of the symbols cited, with constraints: the symbol B must appear before the symbol C, the symbol I before the symbol J . . . )

The implementation of rule (e) is explained in greater detail in French Patent Application No. 9915083 entitled “Dispositif de reconnaissance vocale mettant en oeuvre une régle syntaxique de permutation' [Voice recognition device implementing a syntactic permutation rule] filed in the name of THOMSON Multimedia on Nov. 30, 1999.

The flexible blocks are defined either by virtue of the same BNF syntax as before, or as a list of phrases, or by a vocabulary list and the corresponding n-gram networks, or by the combination of the three. However, this information is translated systematically into an n-gram network and, if the definition has been effected via a BNF file, there is no guarantee that only the sentences which are syntactically correct in relation to this grammar can be produced.

A flexible block is therefore defined by a probability P(S) of appearance of the string S of n words wᵢ of the form (in the case of a trigram):

P(S)=Π_{1,n} P(wᵢ)

With P(wᵢ)=P(wᵢ|wᵢ₋₁, wᵢ₋₂)

For each flexible block, there exists a special block exit word which appears in the n-gram network in the same way as a normal word, but which has no phonetic trace and which permits exit from the block.

Once these syntactic blocks have been defined (of n-gram type or of BNF type), they may again be used as atoms for higher-order constructions:

In the case of a BNF block, the lower level blocks may be used instead of the lexical assignment as well as in the other rules.

In the case of a block of n-gram type, the lower level blocks are used instead of the words wᵢ, and hence several blocks may be chained together with a given probability.

Once the n-gram network has been defined, it is incorporated into the BNF grammar previously described as a particular symbol. As many n-gram networks as necessary may be incorporated into the BNF grammar. The permutations used for the definition of a BNF type block are processed in the search algorithm of the recognition engine by variables of boolean type used to direct the search during the pruning conventionally implemented in this type of situation.

It may be seen that the flexible block exit symbol can also be interpreted as a symbol for backtracking to the block above, which may itself be a flexible block or a rigid block.

Deployment of Triggers

The above formalism is not yet sufficient to describe the language model of a large vocabulary man/machine dialogue application. According to a variant embodiment, a trigger mechanism is appended thereto.

The trigger enables some meaning to be given to a word or to a block, so as to associate it with certain elements. For example, let us assume that the word “documentary” is recognized within the context of an electronic guide for audiovisual programmes. With this word can be associated a list of words such as “wildlife, sports, tourism, etc.”. These words have a meaning in relation to “documentary”, and one of them can be expected to be associated with it.

To do this, we shall denote by <block> a block previously described and by::<block> the realization of this block through one of its instances in the course of the recognition algorithm, that is to say its presence in the chain currently decoded in the n-best search algorithm.

For example, one could have:

<wish>=I would like to go to|want to visit.

<city>=Lyon|Paris|London|Rennes.

<sentence>=<wish> <city>

Then ::<wish> will be: “I would like to go to” for that portion of the paths which is envisaged by the Viterbi algorithm for the possibilities:

I would like to go to Lyon

I would like to go to Paris

I would like to go to London

I would like to go to Rennes

and will be equal to “I want to visit” for the others.

The triggers of the language model are therefore defined as follows:

If <symbol>:: belongs to a given subgroup of the possible realizations of the symbol in question, then another symbol <T(symbol)> which is the target symbol of the current symbol, is either reduced to a subportion of its normal domain of extension, that is to say to its domain of extension if the trigger is not present in the decoding chain, (reducer trigger), or is activated and available, with a non-zero branching factor on exit from each syntactic block belonging to the group of so-called “activator candidates” (activator trigger).

Note that:

It is not necessary for all the blocks to describe a triggering process.

The target of a symbol can be this symbol itself, if it is used in a multiple manner in the language model.

There may, for a block, exist just a subportion of its realization set which is a component of a triggering mechanism, the complementary not itself being a trigger.

The target of an activator trigger can be an optional symbol.

The reducer triggering mechanisms make it possible to deal, in our block language model, with consistent repetitions of topics. Additional information regarding the concept of trigger can be found in the reference document already cited, in particular pages 245-253.

The activator triggering mechanisms make it possible to model certain free syntactic groups in highly inflected languages.

It should be noted that the triggers, their targets and the restriction with regard to the targets, may be determined manually or obtained by an automatic process, for example by a maximum entropy method.

Allowance for the Spoken Language:

The construction described above defines the syntax of the language model, with no allowance for hesitations, resumptions, false starts, changes of mind, etc., which are expected in a spoken style. The phenomena related to the spoken language are difficult to recognize through a grammar, owing to their unpredictable nature. The n-gram networks are more suitable for recognizing this kind of phenomenon.

These phenomena related to the spoken language may be classed into five categories:

Simple hesitation: I would like (errrr . . . silence) to go to Lyon.

Simple repetition, in which a portion of the sentence, (often the determiners and the articles, but sometimes whole pieces of sentence), are quite simply repeated: I would like to go to (to to to) Lyon.

Simple exchange, in the course of which a formulation is replaced, along the way, by a formulation with the same meaning, but syntactically different: I would like to visit (errrr go to) Lyon

Change of mind: a portion of sentence is corrected, with a different meaning, in the course of the utterance: I would like to go to Lyon, (errrr to Paris).

Mumbling: I would like to go to (Praris Errr) Paris.

The first two phenomena are the most frequent: around 80% of hesitations are classed in one of these groups.

The language model of the invention deals with these phenomena as follows:

Simple Hesitation:

Simple hesitation is dealt with by creating words associated with the phonetic traces marking hesitation in the relevant language, and which are dealt with in the same way as the others in relation to the language model (probability of appearance, of being followed by a silence, etc.), and in the phonetic models (coarticulation, etc.).

It has been noted that simple hesitations occur at specific places in a sentence, for example: between the first verb and the second verb. To deal with them, an example of a rule of writing in accordance with the present invention consists of:

<verb group>=<first verb> <n-gram network> <second verb>

Simple Repetition:

Simple repetition is dealt with through a technique of cache which contains the sentence currently analysed at this step of the decoding. There exists, in the language model, a fixed probability of there being branching in the cache. Cache exit is connected to the blockwise language model, with resumption of the state reached before the activation of the cache.

The cache in fact contains the last block of the current piece of sentence, and this block can be repeated. On the other hand, if it is the penultimate block, it cannot be dealt with by such a cache, and the whole sentence then has to be reviewed.

When involving a repetition with regard to articles, and for the languages where this is relevant, the cache comprises the article and its associated forms, by change of number and of gender.

In French for example, the cache for “de” contains “du” and “des”. Modification of gender and of number is in fact frequent.

Simple Exchange and Change of Mind:

Simple exchange is dealt with by creating groups of associated blocks between which a simple exchange is possible, that is to say there exists a probability of there being exit from the block and branching to the start of one of the other blocks of the group.

For simple exchange, block exit is coupled with a triggering, in the blocks associated with the same group, of subportions of like meaning.

For change of mind, either there is no triggering, or there is triggering with regard to the subportions of distinct meaning.

It is also possible not to resort to triggering, and to class hesitation by a posteriori analysis.

Mumbling:

This is dealt with as a simple repetition.

The advantage of this mode of dealing with hesitations (except for simple hesitation) is that the creating of the associated groups boosts the rate of recognition with respect to a sentence with no hesitation, on account of the redundancy of semantic information present. On the other hand, the computational burden is greater.

References

(1) Self-Organized language modelling for speech recognition, F. Jelinek, Readings in speech recognition, p. 450-506, Morgan Kaufman Publishers, 1990

(2) Basic methods of probabilistic context free grammars, F. Jelinek, J. D. Lafferty, R. L. Mercer, NATO ASI Series Vol. 75, p. 345-359, 1992

(3) Trigger-Based language models: A maximum entropy approach, R. Lau, R. Rosenfeld, S. Roukos, Proceedings IEEE ICASSP, 1993

(4) Statistical methods for speech recognition, F. Jelinek, MIT Press, ISBN 0-262-10066-5, pp. 245-253

1. Voice recognition device (1) comprising an audio processor (2) for the acquisition of an audio signal and a linguistic decoder (6) for determining a sequence of words corresponding to the audio signal, the decoder comprising a language model (8), characterized in that the language model (8) is determined by a first set of at least one rigid syntactic block and a second set of at least one flexible syntactic block.

2. Device according to claim 1, characterized in that the first set of at least one rigid syntactic block is defined by a BNF type grammar.

3. Device according to claims 1 or 2, characterized in that the second set of at least one flexible syntactic block is defined by one or more n-gram networks, the data of the n-gram networks being produced with the aid of a grammar or of a list of phrases.

4. Device according to claim 3, characterized in that the n-gram network contains data corresponding to one or more of the following phenomena: simple hesitation, simple repetition, simple exchange, change of mind, mumbling.
